(19) United States
(12) Patent Application Publication
(10) Pub. No.: US 2009/0180296 A1
(43) Pub. Date: Jul. 16, 2009

(54) LOGO DISPLAY

(75) Inventors: JYH-MING CHEN, Chu-Nan (TW); FENG-CHENG CHUNG, Chu-Nan (TW); TSE-AN LEE, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/206,176

(22) Filed: Sep. 8, 2008

(30) Foreign Application Priority Data
Jan. 16, 2008 (CN) 200810300108.7

(51) Int. Cl. F21V 8/00

(52) U.S. Cl. 362/604

(57) ABSTRACT

A logo display includes a light guide plate and a light source. The light guide plate includes a light incident surface and a light output surface. The light output surface has a logo pattern and a number of microstructures thereon. The microstructures are arranged along a contour of the logo pattern. The light source is arranged adjacent to the light incident surface and configured for emitting light beams. The microstructures are structured and arranged in a manner such that the light beams exiting from the output surface illuminate the logo pattern and the microstructures, and the light intensity at the microstructures is greater than that at the logo pattern, thus producing a stereoscopic logo pattern.

### BACKGROUND

1. Technical Field

The present invention relates to logo displays, and particularly, to a logo display with a light guide plate.

2. Description of Related Art

Logo displays are widely used indoors and outdoors for displaying logo patterns.

In a typical logo display, a logo pattern is adhered or painted on a light guide plate, and a light source is configured for illuminating the logo pattern and as well as the light guide plate. However, the logo pattern is two-dimensional designed, the logo display can not show a stereoscopic of the logo pattern.

In another typical logo display, a logo pattern is formed on a surface of a light guide plate, and a light source is configured for illuminating the light guide plate. However, a part of the logo pattern, which is far away from the light source, may be not clear enough in vision.

What is needed, therefore, is a logo display which can show a stereoscopic of the logo pattern thereof, and the logo pattern thereof can be seen more clearly.

### SUMMARY

A logo display includes a light guide plate and a light source. The light guide plate includes a light incident surface and a light output surface. The light output surface has a logo pattern and a number of microstructures thereon. The microstructures are arranged along a contour of the logo pattern. The light source is arranged adjacent to the light incident surface and configured for emitting light beams. The microstructures are structured and arranged in a manner such that the light beams exiting from the output surface illuminate the logo pattern and the microstructures, and the light intensity at the microstructures is greater than that at the logo pattern, thus producing a stereoscopic logo pattern.

Other advantages and novel features of the present logo display will become more apparent from the following detailed description of embodiment when taken in conjunction with the accompanying drawings.

### BRIEF DESCRIPTION OF THE DRAWINGS

Many aspects of the logo display can be better understood with reference to the following drawings. The components in the drawings are not necessarily drawn to scale, the emphasis instead being placed upon clearly illustrating the principles of the present logo display. Moreover, in the drawings, like reference numerals designate corresponding parts throughout the several views.

FIG. 1 is a schematic view of the logo plate in accordance with an embodiment of present invention.

FIG. 2 is a schematic view showing the microstructures in FIG. 1.

FIG. 3 is another schematic view showing the microstructures in FIG. 1.

FIG. 4 is a light intensity diagram of the output surface of the light guide plate in FIG. 1.

### DETAILED DESCRIPTION OF THE EMBODIMENTS

Embodiments of the present logo display will now be described in detail below and with reference to the drawings.

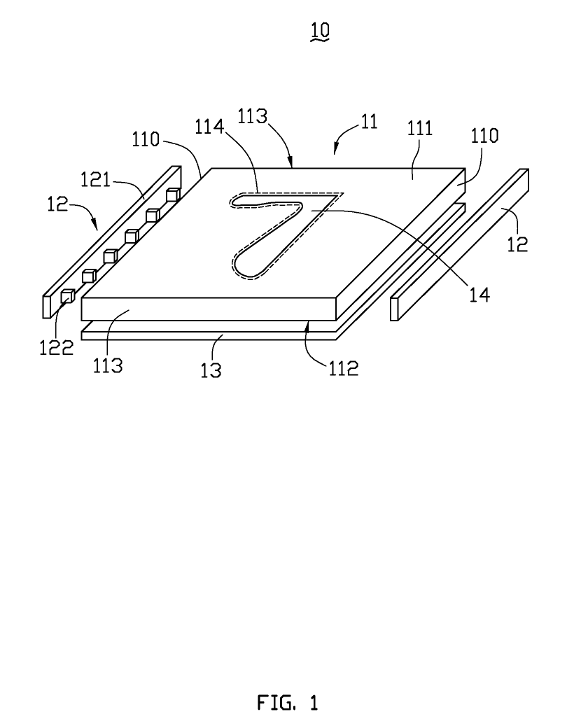

Referring to FIG. 1, a display apparatus 10 is provided. The display apparatus 10 includes a light guide plate 11, two light sources 12 and a reflecting plate 13.

The light guide plate 11 is rectangular shaped, and includes two light incident surfaces 110, a light output surface 111, a bottom surface 112 and two opposite side surfaces 113. The light output surface 111 is opposite to the bottom surface 112. The two light incident surfaces 110 are opposite to each other, and are connected to the light output surface 111 and the bottom surface 112. The reflecting plate 13 is arranged adjacent to the bottom surface 112.

A logo pattern 14 and a number of microstructures 114 are defined on the light output surface 111 of the light guide plate 11. The microstructures 114 are arranged along a contour of the logo pattern 14. The logo pattern 14, the microstructures 114 and the light guide plate 11 can be integrally formed into a unitary piece. Alternatively, the microstructures 114 can be formed on the light guide plate 11 by etching or laser engraving, while the logo pattern 14 is preformed and then adhered directly on the light guide plate 11.

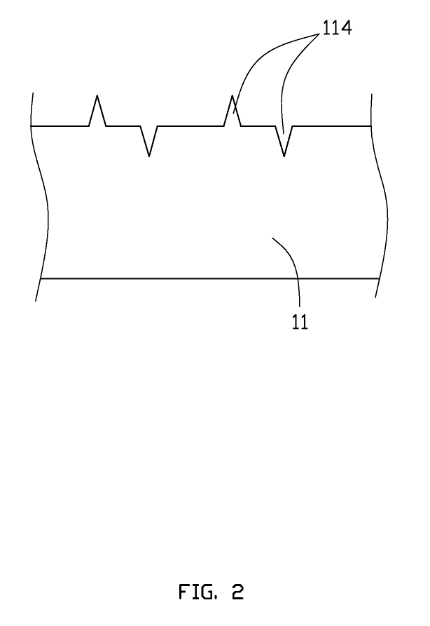

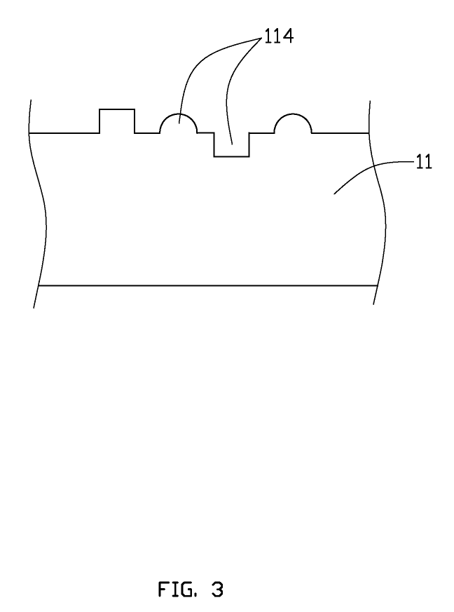

The microstructures 114 can be recesses, protrusions or any combination thereof. A profile of each of the microstructures 114 can be in a triangular shape, more simply, in a V-cut shape (see FIG. 2), or in a rectangular or semi-spherical shape (see FIG. 3).

The two light sources 12 are arranged adjacent to the respective two light incident surfaces 110 of the light guide plate 11. Each of the light sources 12 includes a base 121 and a number of light emitting diodes (LEDs) 122 arranged on the base 121. The LEDs 122 of each of the light source 12 are arranged in a straight line facing the light incident surface 110.

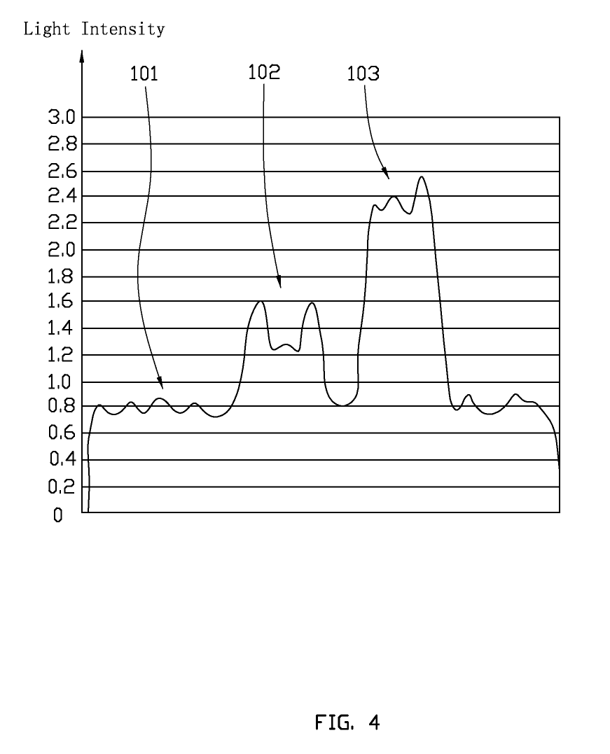

Each of the two light sources 12 is configured for emitting light beams. The light beams are guided in the light guide plate 11 and outputted from the light output surface 111. Due to the microstructures 114, internal total reflection of the light beams in the light guide plate 11 can be reduced. More light beams would be scattered by the microstructures 114, and be outputted via the microstructures 114. Referring to FIG. 4, a light intensity diagram of the light output surface 111 is shown, wherein the section 101 represents light beams outputted from a smooth surface without any microstructures, the section 102 represents light beams outputted from a recess microstructure, and the section 103 represents light beams outputted from a protrusion microstructure. The light intensity of the section 102 is almost two times greater than that of the section 101, while the light intensity of the section 103 is almost three times greater than that of the section 101. That is, light intensity of the light beams outputted via the microstructures 114 may be greater than that via the logo pattern 14. In this way, a light intensity difference can be achieved between the logo pattern 14 and the contour of thelogo pattern 14, thus, in vision, a stereoscopic of the logo pattern 14 is produced.

Simultaneously, due to the stereoscopic and the two light sources 12, the logo pattern 14 can be seen more clearly.

A plurality of dots (not shown) can be formed on the bottom surface 112 of the light guide plate 11 to make the light transmission in the light guide plate 11 uniform. The reflecting plate 13 is configured for reflecting the light transmitting through the bottom surface 112 of the light guide plate 11 to the inner of light guide plate 11, in this way, light loss can be reduced.

A reflecting film (not shown) can also be adhered on each of the two side surfaces 113 to reduce light loss.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A logo display, comprising:
a light guide plate having a light incident surface and a light output surface, the light output surface having a logo pattern and a plurality of microstructures thereon, the microstructures being arranged along a contour of the logo pattern;
a light source arranged adjacent to the light incident surface and configured for emitting light beams, the microstructures being structured and arranged in a manner such that the light beams exiting from the output surface illuminate the logo pattern and the microstructures, and the light intensity at the microstructures is greater than that at the logo pattern, thus producing a stereoscopic logo pattern.

2. The logo display of claim 1, wherein the microstructures are selected from a group consisting of recesses, protrusions and any combination thereof.

3. The logo display of claim 2, wherein a profile of each microstructure is in a triangular, rectangular or semi-spherical shape.

4. The logo display of claim 1, wherein the logo pattern, the microstructures and the light guide plate are integrally formed into a unitary piece.

5. The logo display of claim 1, wherein the logo pattern is adhered on the light guide plate.

6. The logo display of claim 1, wherein the light guide plate has a bottom surface opposite to the light output surface, the light incident surface adjoining the bottom surface and light output surface, a reflecting plate being arranged adjacent to the bottom surface.

7. The logo display of claim 1, wherein the light source comprises a base and a plurality of light emitting diodes arranged on the base, the light emitting diodes facing the light incident surface.

8. The logo display of claim 7, wherein the light emitting diodes are arranged in a straight line.

9. A device comprising:
a light guide plate having a light incident surface and a flat light output surface,
a logo pattern arranged on the light output surface,
a plurality of light scattering structures arranged on the light output surface, the light scattering structures forming a contour of the logo pattern;
a light source arranged adjacent to the light incident surface and configured for emitting light beams to illuminate the light scattering structures in a manner that the light intensity at the light scattering structures is greater than that at the logo pattern, thus producing a stereoscopic logo pattern.

10. The device of claim 9, wherein the light scattering structures are selected from a group consisting of recesses, protrusions and any combination thereof.

11. The device of claim 9, wherein the logo pattern, the microstructures and the light guide plate are integrally formed into a unitary piece.

12. The device of claim 9, wherein the logo pattern is adhered on the light guide plate.

13. The device of claim 9, wherein the light guide plate has a bottom surface opposite to the light output surface, the light incident surface adjoining the bottom surface and light output surface, a reflecting plate being arranged adjacent to the bottom surface.

14. The device of claim 9, wherein the light source comprises a base and a plurality of light emitting diodes arranged on the base, the light emitting diodes facing the light incident surface.

15. The device of claim 14, wherein the light emitting diodes are arranged in a straight line.
